(19) United States
(12) Patent Application Publication
(10) Pub. No.: US 2010/0083091 A1
(43) Pub. Date: Apr. 1, 2010

(54) Dynamic text escaping

(75) Inventors: Peter Glen Berger, Irwin, PA (US); Tamara Lynn Abell, Pittsburgh, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,716

(22) Filed: Sep. 30, 2008

(51) Int. Cl. G06F 17/00

(52) U.S. Cl. 715/220

(57) ABSTRACT

In some embodiments, text that includes one or more prescribed characters is represented on a pasteboard in a plurality of representations, including an escaped representation that escapes the one or more prescribed characters so that a format of the text can be preserved when the text is pasted into a cell of a spreadsheet application that does not natively support inclusion of the one or more prescribed characters in cell content.

### BACKGROUND OF THE INVENTION

In some existing spreadsheet applications, certain whitespace characters are defined to have prescribed functions and can not be employed with respect to content included in a cell. For example, a tab results in a current selected cell to become deselected and an adjacent cell in the next column but same row to become selected, and a carriage return results in a current selected cell to become deselected and an adjacent cell in the same column but next row to become selected. Other existing spreadsheet applications allow whitespace characters such as tabs and carriage returns to be included with respect to content included in a cell.

Copying text that includes certain whitespace characters and pasting the copied text into a cell of a typical spreadsheet application that does not natively support inclusion of those whitespace characters in the content of a cell may result in the copied text to be pasted into multiple cells rather than a single cell, which may not be desirable. Examples of copying and pasting text that includes such whitespace characters are provided with respect to FIGS. 1A-11H.

FIGS. 1A-1D illustrate prior art examples of copying text from a cell of a first spreadsheet application (“Spreadsheet Application A”) that includes a tab and pasting the copied text into a cell of a second spreadsheet application (“Spreadsheet Application B”) that does not support tabs to be included in cell content. FIG. 1A illustrates a set of cells of Spreadsheet Application A. As depicted, cell A1 comprises text that includes a tab. FIG. 1B illustrates the selection of an option to copy the content of cell A1. The copied content is added as the most recent entry into an associated pasteboard. FIG. 1C illustrates the selection of an option to paste with respect to a cell A1 in Spreadsheet Application B. FIG. 1D illustrates the result of the paste operation in Spreadsheet Application B. As depicted in FIG. 1D, the tab in the copied text results in the copied text to be pasted into multiple cells. That is, the tab in the copied text results in the portion of the copied text after the tab to be pasted into the next column, i.e., into cell B1.

FIGS. 1E-1H illustrate prior art examples of copying text from a cell of a first spreadsheet application (“Spreadsheet Application A”) that includes a carriage return and pasting the copied text into a cell of a second spreadsheet application (“Spreadsheet Application B”) that does not support carriage returns to be included in cell content. FIG. 1E illustrates a set of cells of Spreadsheet Application A. As depicted, cell A1 comprises text that includes a carriage return. FIG. 1F illustrates the selection of an option to copy the content of cell A1. The copied content is added as the most recent entry into an associated pasteboard. FIG. 1G illustrates the selection of an option to paste with respect to a cell A1 in Spreadsheet Application B. FIG. 1H illustrates the result of the paste operation in Spreadsheet Application B. As depicted in FIG. 1H, the carriage return in the copied text results in the copied text to be pasted into multiple cells. That is, the carriage return in the copied text results in the portion of the copied text after the carriage return to be pasted into the next row, i.e., into cell A2.

### BRIEF DESCRIPTION OF THE DRAWINGS

Various embodiments of the invention are disclosed in the following detailed description and the accompanying drawings.

FIGS. 1A-1D illustrate prior art examples of copying and pasting text that includes a tab.

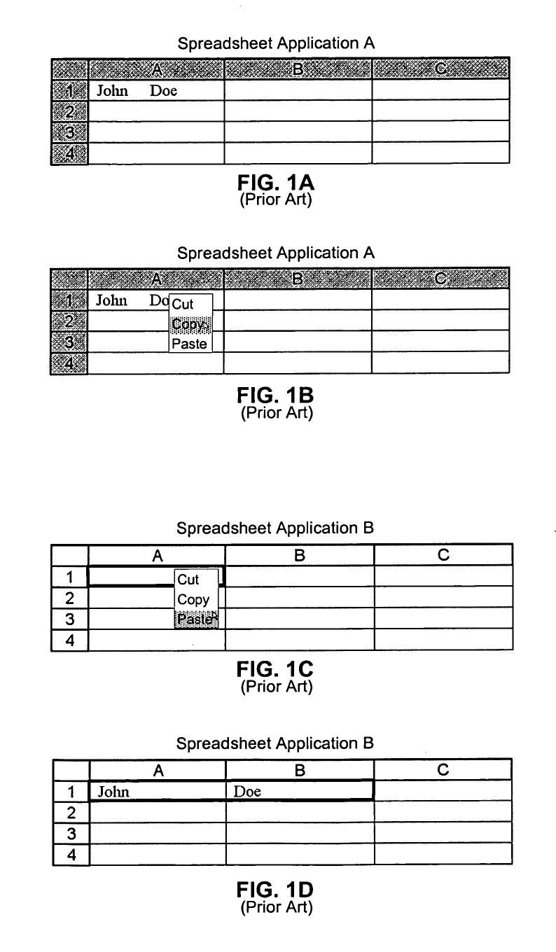

FIGS. 1E-1H illustrate prior art examples of copying and pasting text that includes a carriage return.

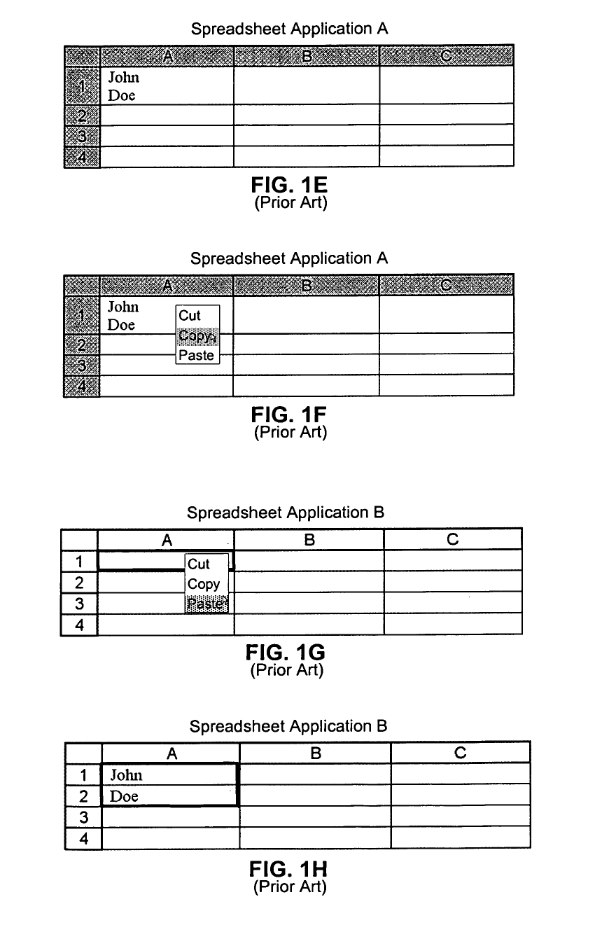

FIG. 2 illustrates an embodiment of a process for adding content to a pasteboard.

FIG. 3 illustrates an embodiment of a process for pasting content.

FIGS. 4A-4D illustrate embodiments of copying and pasting text that includes a tab.

FIGS. 4E-4H illustrate embodiments of copying and pasting text that includes a carriage return.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. Although many of the examples provided herein are with respect to copying and pasting between different spreadsheet applications, the described techniques may be similarly employed when copying text that includes one or more prescribed characters from any application and pasting the copied text into a spreadsheet application that does not natively support inclusion of the one or more prescribed characters in cell content.

Dynamic text escaping is disclosed. In some embodiments, when text that includes one or more prescribed whitespace characters (e.g., tabs, carriage returns, etc.) is added to an associated clipboard or pasteboard, the text is represented in a plurality of different pasteboard text representations. In some embodiments, the plurality of representations includes both a native representation and one or more other representations that have a higher probability of being recognized and accurately interpreted by certain other applications into which the text may be pasted. When such copied text is pasted into another application, the representation determined dynamically to be the most appropriate for the destination application, for example the one that is closest to the native format of that application, is selected, e.g., by the destination application, thereby enabling the fidelity of the original copied content to be preserved to the extent possible.

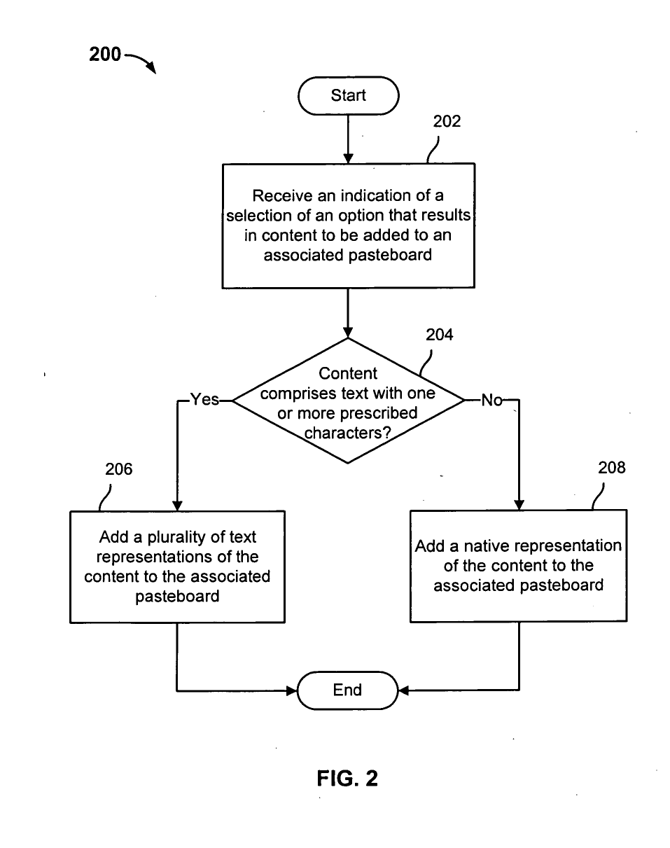

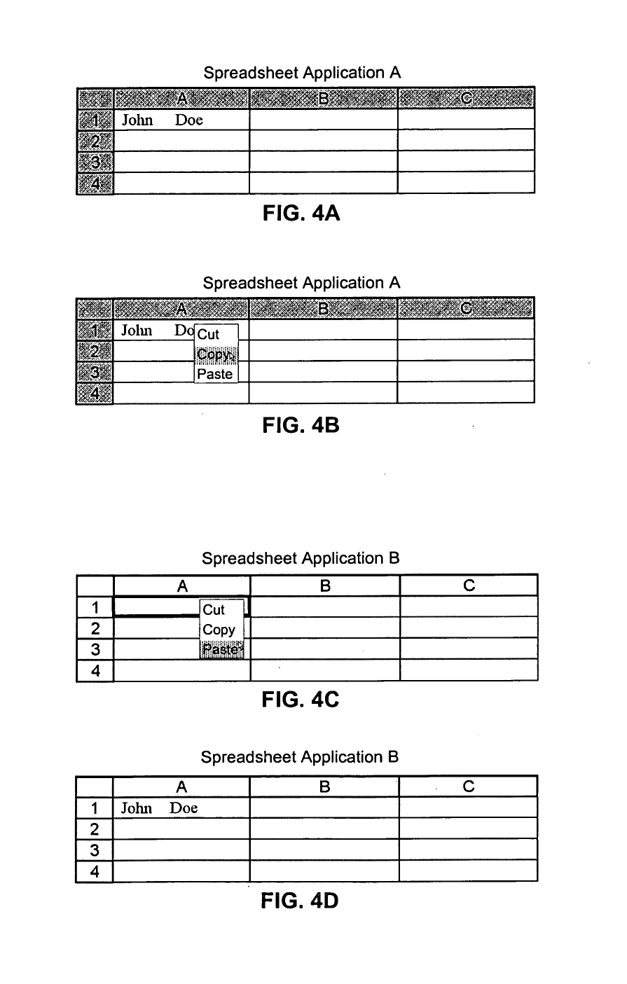

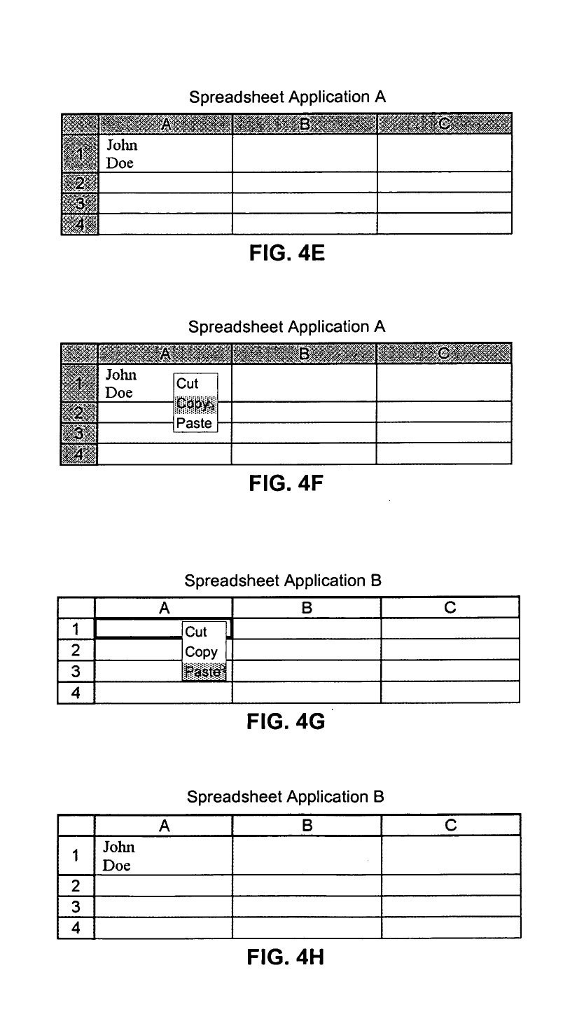

FIG. 2 illustrates an embodiment of a process for adding content to a pasteboard. In some embodiments, process 200 is employed with respect to the copy operations illustrated in FIGS. 4B and 4F and further described below. Process 200 starts at 202 at which an indication of a selection of an option that results in content to be added to an associated pasteboard is received. For example, the option may comprise a “cut” or “copy” option. In some embodiments, the indication is received with respect to a cell (or a plurality or range of cells) of a spreadsheet application that allows one or more prescribed whitespace characters to be included in text entered into cells. At 204, it is determined whether the content comprises text that includes one or more prescribed whitespace characters, such as tabs and/or carriage returns. If it is determined at 204 that the content comprises text with one or more prescribed whitespace characters, the content is added to the associated pasteboard in a plurality of text representations at 206, and process 200 subsequently ends. In some embodiments, the plurality of text representations includes an “escaped” representation that is at least in part compatible with and/or can be employed by an (spreadsheet) application that does not natively support the inclusion of the prescribed whitespace characters in text. In some embodiments of the escaped representation, one or more escape characters are added to the content, e.g., to escape the prescribed whitespace characters. In some embodiment, the escape characters comprise quotation marks. For example, in some embodiments, text that includes one or more prescribed whitespace characters is wrapped in one or more sets of quotation marks, as appropriate. In some embodiments, the plurality of text representations includes a native representation that can be employed, for example, by applications that support the native representation and that may not be able to correctly interpret the escaped representation (e.g., use of the escaped representation by such an application may result in the escape characters to be presented when the content is pasted). In some cases, the native representation comprises a WYSIWYG (What You See Is What You Get) plain text representation of the content. If it is determined at 204 that the content does not comprise text with one or more prescribed whitespace characters, the content is added to the associated pasteboard in an associated native representation at 208, and process 200 subsequently ends. For example, if the content comprises text that does not include one or more prescribed whitespace characters, a WYSIWYG plain text representation of the content is added to the pasteboard at 208 in some embodiments.

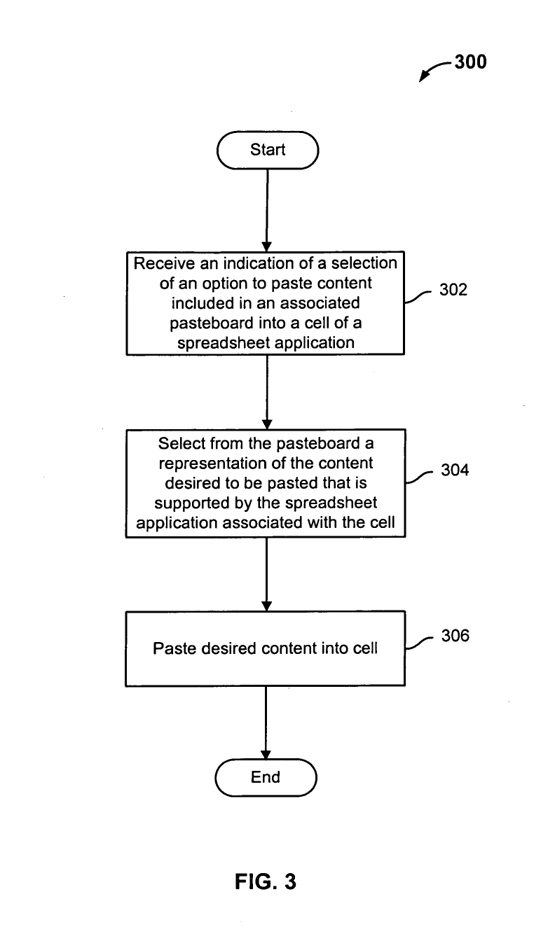

FIG. 3 illustrates an embodiment of a process for pasting content. For example, process 300 may be employed to paste content added to an associated pasteboard using process 200 of FIG. 2. In some embodiments, process 300 is employed with respect to the paste operations illustrated in FIGS. 4C-4D and FIGS. 4G-4H, which are further described below. Process 300 starts at 302 at which an indication of a selection of an option to paste content included in an associated pasteboard into a cell of a spreadsheet application is received. For example, the option may comprise a “paste” or “paste special” option. At 304, a representation of the content desired to be pasted that is supported by the spreadsheet application associated with the cell is selected from the pasteboard. For example, depending on which spreadsheet application is associated with the cell with respect to which the paste operation is being performed, an escaped representation or a native representation of the content desired to be pasted may be selected at 304. At 306, the desired content is pasted into the cell, and process 300 subsequently ends. In some embodiments, escape characters associated with an escaped representation are recognized and removed by the destination spreadsheet application when the content is pasted into the cell at 306. In some embodiments, the escaped representation allows the original formatting of text that includes one or more prescribed whitespace characters to at least in part be preserved, e.g., when such text is pasted into a destination application that does not natively support the inclusion of the prescribed whitespace characters in text. For example, the cell span of text copied from a source spreadsheet application may be preserved when an escaped representation of the text is employed to paste the copied text into a destination spreadsheet application as further illustrated and described with respect to the examples of FIGS. 4A-4H below.

FIGS. 4A-4D illustrate embodiments of copying text from a cell of a first spreadsheet application (“Spreadsheet Application A”) that includes a tab and pasting the copied text into a cell of a second spreadsheet application (“Spreadsheet Application B”) that does not natively support the inclusion of tabs in cell content. FIG. 4A illustrates a set of cells of Spreadsheet Application A. As depicted, the text in cell A1 includes a tab. FIG. 4B illustrates the selection of an option to copy the content of cell A1. The copied content is added as the most recent entry into an associated pasteboard. In some embodiments, the copied text is added to, the associated pasteboard in a plurality of text representations, including, for example, native and escaped representations. FIG. 4C illustrates the selection of an option to paste with respect to a cell A1 in Spreadsheet Application B. FIG. 4D illustrates the result of the paste operation in Spreadsheet Application B. As depicted in FIG. 4D, the cell span of the copied and pasted text is maintained, i.e., the text is pasted into a single cell. In this example, Spreadsheet Application B is configured to dynamically select the escaped representation of the copied text from the pasteboard, recognize the escape characters in the escaped representation, and based thereon allow the tab to be included in cell A1.

FIGS. 4E-4H illustrate embodiments of copying text from a cell of a first spreadsheet application (“Spreadsheet Application A”) that includes a carriage return and pasting the copied text into a cell of a second spreadsheet application (“Spreadsheet Application B”) that does not natively support the inclusion of carriage returns in cell content. FIG. 4E illustrates a set of cells of Spreadsheet Application A. As depicted, the text in cell A1 includes a carriage return. FIG. 4F illustrates the selection of an option to copy the content of cell A1. The copied content is added as the most recent entry into an associated pasteboard. In some embodiments, the copied text is added to the associated pasteboard in a plurality of text representations, including, for example, native and escaped representations. FIG. 4G illustrates the selection of an option to paste with respect to a cell A1 in Spreadsheet Application B. FIG. 4H illustrates the result of the paste operation in Spreadsheet Application B. As depicted in FIG. 4H, the cell span of the copied and pasted text is maintained, i.e., the text is pasted into a single cell. In this example, Spreadsheet Application B is configured to dynamically select the escaped representation of the copied text from the pasteboard, recognize the escape characters in the escaped representation, and based thereon allow the carriage return to be included in cell A1.

As described, in some embodiments, an escaped representation of text that includes one or more prescribed characters that may not be natively supported by other applications is dynamically added to a pasteboard in addition to a native representation when an option to copy or cut the text is selected. Such an escaped representation may allow compatibility to at least in part be maintained between different (spreadsheet) applications.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for processing data, the computer program product being embodied in a computer readable storage medium and comprising computer instructions for:
determining that a text that is to be added to a pasteboard includes one or more prescribed characters; and
representing the text in a plurality of representations in the pasteboard, including an escaped representation that escapes the one or more prescribed characters so that a format of the text can be preserved when the text is pasted into a cell of a spreadsheet application that does not natively support inclusion of the one or more prescribed characters in cell content.

2. The computer program product recited in claim 1, wherein the one or more prescribed characters comprise certain whitespace characters.

3. The computer program product recited in claim 1, wherein the one or more prescribed characters comprise tabs, carriage returns, or both.

4. The computer program product recited in claim 1, wherein the spreadsheet application comprises a destination spreadsheet application and wherein the text comprises content of a cell of a source spreadsheet application that allows inclusion of the one or more prescribed characters in cell content.

5. The computer program product recited in claim 4, wherein the format of the text comprises a cell span of the text in the source spreadsheet application.

6. The computer program product recited in claim 1, wherein the escaped representation includes one or more escape characters.

7. The computer program product recited in claim 6, wherein the escape characters comprise quotation marks.

8. The computer program product recited in claim 6, wherein the spreadsheet application is configured to recognize the escape characters and based thereon allow the one or more prescribed characters to be included in cell content.

9. The computer program product recited in claim 1, wherein the plurality of representations includes a native representation associated with a source application from which the text is being added to the pasteboard.

10. The computer program product recited in claim 9, wherein the native representation comprises a WYSIWYG (What You See Is What You Get) plain text representation.

11. A system for processing data, comprising:
a processor configured to:
determine that a text that is to be added to a pasteboard includes one or more prescribed characters; and
represent the text in a plurality of representations in the pasteboard, including an escaped representation that escapes the one or more prescribed characters so that a format of the text can be preserved when the text is pasted into a cell of a spreadsheet application that does not natively support inclusion of the one or more prescribed characters in cell content; and
a memory coupled to the processor and configured to provide the processor with instructions.

12. The system recited in claim 11, wherein the one or more prescribed characters comprise certain whitespace characters.

13. The system recited in claim 11, wherein the spreadsheet application comprises a destination spreadsheet application and wherein the text comprises content of a cell of a source spreadsheet application that allows inclusion of the one or more prescribed characters in cell content.

14. The system recited in claim 13, wherein the format of the text comprises a cell span of the text in the source spreadsheet application.

15. The system recited in claim 11, wherein the plurality of representations includes a native representation associated with a source application from which the text is being added to the pasteboard.

16. A method for processing data, comprising:
determining that a text that is to be added to a pasteboard includes one or more prescribed characters; and
representing the text in a plurality of representations in the pasteboard, including an escaped representation that escapes the one or more prescribed characters so that a format of the text can be preserved when the text is pasted into a cell of a spreadsheet application that does not natively support inclusion of the one or more prescribed characters in cell content.

17. The method recited in claim 16, wherein the one or more prescribed characters comprise certain whitespace characters.

18. The method recited in claim 16, wherein the spreadsheet application comprises a destination spreadsheet application and wherein the text comprises content of a cell of a source spreadsheet application that allows inclusion of the one or more prescribed characters in cell content.

19. The method recited in claim 18, wherein the format of the text comprises a cell span of the text in the source spreadsheet application.

20. The method recited in claim 16, wherein the plurality of representations includes a native representation associated with a source application from which the text is being added to the pasteboard.
